(19) United States
(12) Patent Application Publication
(10) Pub. No.: US 2002/0092708 A1
(43) Pub. Date: Jul. 18, 2002

(54) Quick coupler system

(76) Inventor: Elmer Secker, Green Bay, WI (US)

Correspondence Address: Philip M. Weiss, Esq., Suite 305, 500 Old Country Road, Garden City, NY, 11530, US

(21) Appl. No.: 09/761,118

(22) Filed: Jan. 16, 2001

(51) Int. Cl. B66F 9/12; B66F 9/06

(52) U.S. Cl. 187/237; 414/785; 414/814

(57) ABSTRACT

The present invention relates to a system for attaching an additional set of forks or some other apparatus to a carriage without having to remove the existing tines.

### FIELD OF THE INVENTION

The present invention relates to a system for attaching an additional set of forks or some other apparatus to a carriage of a forklift, fork truck, wheel loader or backhoe, without having to remove the existing tines.

### BACKGROUND OF THE INVENTION

Prior designs to connect individual tines to a forklift or fork truck have involved manually (by hand and with the assistance of additional lift equipment) sliding a tine onto a round solid shaft or a solid bar with a lip. (A tine is a forged steel blade/fork used on forklifts and fork trucks to lift materials.) This method is difficult because the weight of each tine maybe 100 to 2000 lbs. each. Because this is a cumbersome task, once a set of tines is installed on a forklift or fork truck, most facilities leave those tines permanently installed. Throughout the day, these facilities are lifting and moving various types of materials. There are situations where a different type of tine, fork, or other lift apparatus may operate more effectively and more safely, when lifting various materials.

Other machines, such as wheel loaders, may have quick coupler systems, whereas the operator may disconnect the carriage with the tines entirely, and move the machine and reconnect to a complete separate unit. This type of coupler system generally requires a great investment. Furthermore this type of system usually requires hydraulic controls or modifications to the machine itself to install and operate such.

Forklifts and fork trucks usually have a carriage unit that is attached directly to the lift mast, and such quick coupler systems mentioned in the preceding paragraph are not available.

Typical problems that presently occur when using one size of tines to lift all types of materials include:

Tines breaking from improper lift applications

Tines breaking from extensions being added, thus using the tine beyond it's designed stress and load capacities

Materials being moved are damaged from using incorrect size of tines

Materials tipping and falling off the tines because of the tines not being the

correct size to stabilize the materials and associated safety hazards and costs

Typical problems that presently occur when changing tines, may include:

Time cost for personnel, wages for labor

Possible risk of personal injury in handling a tine that is 100 to 2000 lbs.

Downtime for machine, lost productivity

Typical problems that presently occur with existing quick coupler systems are:

Not available to forklifts and fork trucks with carriages permanently welded to the mast

Usually require modification to the existing hydraulic system or controls.

U.S. Pat. No. 5,984,019 relates to a hitching device to a three-point hitch, or to a quick-attaching coupler on a three-point hitch, having a frame removably coupled to the draft links of the three-point hitch or hooks of a quick attaching coupler. The frame has a horizontal member adapted to allow attachment of an implement. The horizontal member is disposed at a location that is below the draft links and that is forward of the ends of the draft links so that the horizontal member is closer to the tractor or other drive vehicle than the ends of the draft links. An alternative embodiment of hitching device includes an elevated hitch ball on top thereof for accommodating a fifth wheel trailer hitch. A pair of tine receiving slots is positioned in the two lowermost corners of the alternative hitching device frame for receiving a respective pair of rearwardly extending forklift tines.

U.S. Pat. No. 4,544,323 relates to a universal vertical lift system couplings and attachments therefor, in vertical lift systems, improvements in wide engagement and narrow engagement universal couples and attachments; and improvements in couples of vertical lift systems, both wide gauge and narrow gauge, which permit attachment engagements be fixed directly to the working attachment member, rather than requiring the conventional intermediate universal support or carry. This patent relates to interchanging body units on truck chassis, like a dump truck, garbage truck or flat bed truck.

U.S. Pat. No. 4,456,414 relates to a quick coupling apparatus for interchangeable truck bodies. A quick coupling apparatus is provided for interchanging any number of vehicle body units on a single vehicle chassis when each of the body units and the chassis has a pair of parallel longitudinal standardly spaced beams whereby the beams of the body unit will overlie and be supported by the chassis beams when the components are coupled. The coupling apparatus has a plurality of hook-type tabs spacedly positioned on the sides of the body beams and a corresponding number of coupling brackets mounted on the sides of the chassis beams. Each of the coupling brackets being capable of receiving a tab and securing the body unit to the chassis when the body is moved slightly in a longitudinal coupling direction. At least one of the coupling brackets having an enclosing outer plate, which forms a retaining slot which can receive a wedge behind the tab for locking the tab and body in position with respect to the chassis.

U.S. Pat. No. 4,424,982 relates to an attachment device for facilitating the attachment of various implements to the chassis of a motor vehicle. The attaching device includes a first frame having a pair of generally L-shaped support members with vertical and horizontal legs. The vertical legs are connected together at an upper end by a cross bracket and are tiltable relative to the chassis of the vehicle by a hydraulic cylinder connected between the chassis and the cross bracket. The horizontal legs are pivotally attached at one end to a lower point of the chassis and permit the first frame to pivot there about. A second frame is movably supported by the vertical legs of the first frame and contains a plurality of coupling elements arranged in the preset relationship for easy coupling to an attachable implement.

### SUMMARY OF THE INVENTION

The system of the present invention allows an operator of a forklift or fork truck to attach forks or other apparatus within a few seconds, by simply driving the machine up to the forks or other apparatus, equipped with such a system, engage the lift mechanism for the carriage to lift the carriage to connect the carriage to the hooks on the forks or apparatus, then to engage the hydraulic tine slide mechanism (aka: fork positioner) to slide the tines together to secure against the locking block. This attachment takes a matter of seconds and is totally done by the machine operator from the driver's compartment.

The present invention can be installed on and adapted to forklifts and fork trucks, which currently use a carriage with forged steel tines and is equipped with a fork positioner.

It is an object of the present invention to provide a quick, safe and easy way the machine operator can attach an additional set of specialized forks or some other apparatus to the carriage without having to get out of the operator's seat and without having to remove the existing tines.

The system of the present invention solves problems and offers the following advantages:

With the installation of the system of the present invention the operators of forklifts and fork trucks have a quick and easy choice to attach to forks or the needed apparatus that will enable them to quickly and safely move their materials.

Broken or Cracked Tines:

Currently there are tines breaking because the operator maybe lifting a load that is heavier than the designed load for the tines on the machine. With the coupler system of the present invention the operator can easily attach to the appropriate forks or the needed apparatus that will enable them to quickly and safely move their materials.

The system of the present invention allows forklift and fork truck operators to quickly and easily attach long forks (such as 15′ forks) to the forklift or fork truck, which will provide safe lifting function.

Current operators maybe sliding on individual time extensions, by hand, to provide a longer overall tine to lift something that maybe very long, such as a car, truck, or boat. Several problems are apparent with this example. Tine extensions are a dangerous way of obtaining a longer tine because they are causing more leverage on the tine than it was designed for. Often times machine operators or owners will drill or bum about a 1 inch hole in the tine and the extension, where they can insert a bolt or locking pin, to try to prevent the extension from sliding off unexpectedly. The problem with this hole is that it weakens the original structure of the tine and will eventually cause it to crack. Many operators don't take the time to insert this bolt or pin, which may cause the tine extensions to slide off the tine unexpectedly. This is an unsafe situation. The system of the present invention allows the operator to attach an appropriate fork or other apparatus to safely move the materials.

Materials damaged from use of incorrect size tines

Currently there are materials which are being moved that are being damaged from tines that are not the correct size to lift and move such materials. An example is cars and trucks that are lifted from front to back with forks that do not reach the rear suspension lift points. When forks do not reach the rear suspension lift points, there are parts of the vehicle that are damaged from the tines lifting on them, such as fuel tanks, rocker panels, floors, drive shafts, transfer cases, etc. With the system of the present invention, the operator can quickly and easily attach a set of 15′ Forks to the forklift or fork truck and move the vehicles.

Materials damaged from tipping or falling of tines

When tines are not long enough, or do not provide a wide enough stance to properly balance the load, materials can tip and fall off the tines. This is a safety hazard as well as will cause damage to the materials being lifted. With the system of the present invention the operator can quickly and easily attach an appropriate apparatus that is more suited to lifting and moving such materials.

Costs and Risks associated with the current method of changing tines

Labor is obviously a consideration if an operator was to manually change tines. Possible risk of personal injury in handling a tine that is 100 to 2000 lbs. and the downtime for the machine and lost productivity during the change over process can all be eliminated with use of the system of the present invention.

The system of the present invention allows the machine operator to quickly and easily attach forks or other apparatus within seconds, while remaining in the operator's compartment of the forklift or fork truck.

Installing a the quick coupler system of the present invention on a forklift or fork truck

The system of the present invention can be installed onto forklifts and fork trucks with carriages that are permanently attached to the mast and that have existing hydraulic tine sliding function (fork positioner), without any modification to the machine's hydraulic system or controls.

### BRIEF DESCRIPTION OF THE DRAWINGS

FIG. 1 illustrates a front view of the present invention with a center lock.

FIG. 2 illustrates a front view of the present invention with side locks.

### DETAILED DESCRIPTION THE INVENTION

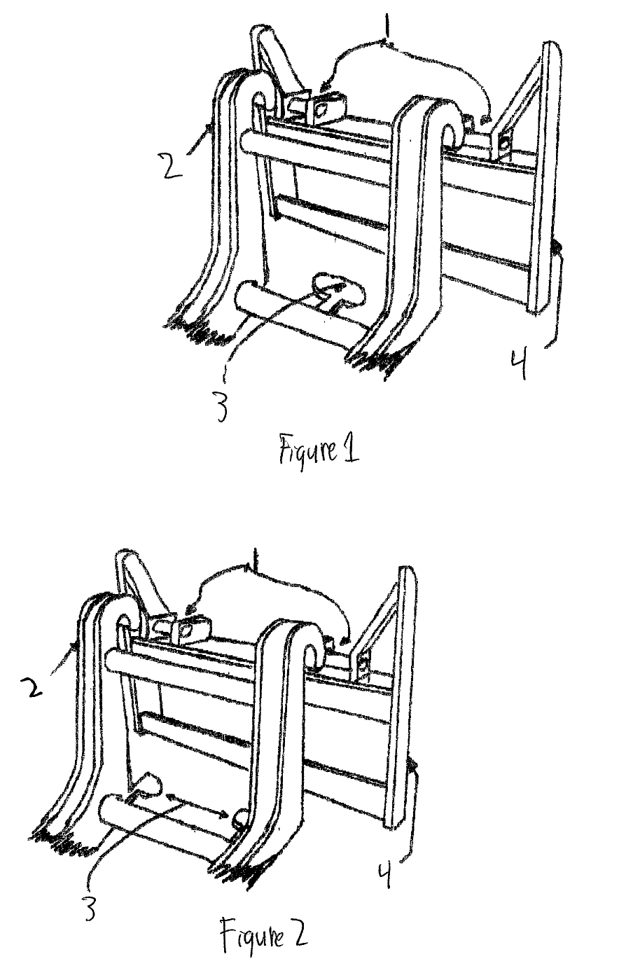

FIG. 1 and FIG. 2 illustrate embodiments of the present invention. In a preferred embodiment, Part 1 comprises one or two round steel shafts, reinforcement plates and side guide plates. Part 2 comprises two hook shaped large steel plates. Part 3 comprises either one locking block centered as shown in FIG. 1, or two locking blocks mirrored in their placement as shown in FIG. 2. Part 4 is a carriage/headache rack.

The present invention involves securing part 1 [one long or two short round solid steel shafts, reinforcement plates and side guide plates] to the upper portion of the carriage headache rack 4, preferably by welding. Part 2 [two hook shaped large steel plates] is attached to the top of the apparatus. Part 3 [a locking block] is attached to the lower portion of the apparatus. Some designs may require a center locking block as in FIG. 1, or some designs may require two locking blocks, part 3 as shown in FIG. 2.

Basic operation of the present invention involves the machine operator driving up to the apparatus equipped with the system of the present invention lowering the carriage, and spreading or closing the tines enough to clear part 3. When part 1 is directly under part 2, the operator engages the lift mechanism of the machine to move the carriage and part 1 to securely hook into part 2. Once parts 1 and 2 are firmly connected, the operator engages the hydraulic tine side to side slide mechanism to slide both tines toward the center to pinch part 3. Alternatively, if the apparatus is fitted with two part 3 [locking blocks] this would require the operator to engage the hydraulic tine slide in a direction that would cause the tines to slide over and lock onto both such 3 parts. Once the tines firmly pinch part 3 to secure the apparatus to the carriage of the machine, the operator can operate the machine to carry out the needed functions of such secured apparatus.

The exact dimensions of and locations of parts 1, 2, and 3 will vary based on several factors: the make and model of forklift or fork truck, on what apparatus is to be attached, the required gross lift capacity, the clearances on the existing carriage and headache rack on the equipment, and the clearances of the existing tines on the carriage compared with the clearance allowances provided by the apparatus that is to be attached via the quick coupler. General design and manufacturing guidelines are provided here for applications up to 5000 lbs. at 5′. The system of the present invention can be designed and applies to virtually any gross lift capacity, machine, or apparatus.

Manufacturing Individual Parts: Below is a list of preferred specifications for the parts of the present invention.

Part 1a) two round solid steel shafts: material: stress proof steel, diameter: 2 ½ inch, total length each: 7 ½ inches, exposed coupler hook connection length each: 5 ½ inches. Manufacture: Shaft material can be cut to the proper length with an industrial band saw. Turn each shaft on a lathe to obtain a 1 inch bevel on each end of both shafts.

Part 1b) four shaft mount plates: material: GR50 or better steel, thickness: 1 inch, minimum size: 4 inch×4 inch, machine out one 2 ½ inch diameter hole in each to the needed offset Manufacture: plates can be cut to proper length with an industrial band saw. Holes can be bored accurately by a CNC machining center.

Part 1c) two side guide plates: material: GR50 or better steel, thickness: 1 inch, length will vary by application. Manufacture: Plates can be cut to length with an industrial band saw.

Part 2a) four primary hook plates (two inner & two outer): material: GR50 or better steel, thickness: 1 ¼ inch each; Curvature of hook area is to be determined by the carriage and headache rack style; Height from ground to upper portion of hook to be determined by design of carriage. Manufacture: Steel hook plates can be accurately cut on a Computer Controlled Laser or a computer controlled oxi-acceteline cutting table with water cooling.

Part 2b) hook structure spacer material: material: GR50 or better steel, thickness 1 ¼ inch; Curvature to be identical to Part 2(a); Length from top of hook down is to be minimum of 7 inches (additional length here maybe required by design for certain applications for stress). Manufacture: Steel hook structure filler material can be accurately cut on a Computer Controlled Laser or a computer controlled oxi-acettline cutting table with water cooling.

Part 3 Design may require none, one or two locking blocks, material GR50 or better steel, thickness 1 ½ inch, desired length to lock behind each tine is at least 2 inches per side. Manufacture: Steel locking blocks can be accurately cut on a Computer Controlled Laser or a computer controlled oxi-acetline cutting table with water cooling.

Additional reinforcement materials maybe necessary, beyond what is covered herein for the basic coupler system itself Assembly of Parts: Using the dimensions determined in the design process for the specific application, locate the placement of the outer and inner shaft mounting plates (Part 1(b)) and tack weld onto the upper bar of the carriage/headache rack 4. Insert the shaft (Part 1(a)) into the shaft mounting plates and tack weld. Place side guide plates (Part 1(c)) and tack weld in place. Weld with a MC710 wire a ½ inch fillet around each mounting plate and guide plate. Weld on the shafts only on the outside edges where the beveled area meets the support plates. Do not weld around the shaft on the inside where the coupler hooks will sit. Place and weld one hook (Part 2(a)) into a secure jig and weld hook structure fill material (Part 2(b)) along with placement of opposite hook plate (Part 2(a)). This welding should be done with a MC710 wire placing a½ fillet around the outside of the top and back face of the hook, not placing a weld directly in the hook area that will make contact with the shaft (Part 1(a)). Repeat this process to construct the second hook assembly. After the two hook assemblies are complete, carefully place them onto the apparatus that is intended to be used with the coupling device. Be sure that the width spacing and the height placement aligns with the shafts welded on top of the carriage and will allow clearance for the existing tines on the carriage, when approaching the apparatus to hook to it, and also when lifting to secure the hook and pin and locking in place the lock blocks (Part 3). After placement is determined tack weld hooks onto the apparatus. Test fit hooks and apparatus to carriage. If all clearances prove to be sufficient, then weld a temporary strong back on the outer edge of the hook assemblies to secure their position, to prevent them from moving when doing the required extensive welding to secure the hooks to the apparatus depending on what the apparatus is going to do. This will determine the exact welding and securing process necessary at this point. In general it would involve a minimum of 30 inches of ½ inch multi-pass bead welding using a MC710 wire and gussets as needed to eliminate high stress points.

A Preferred Embodiment has been designed for the NASCO fork truck. This fork truck is made with a carriage and tines that have a hydraulic tine positioning capability. These machines come equipped with 8 foot long forged steel forks. Operators of this fork truck use it to move pallets of materials into and out of semi trailers and to move other materials around their facilities. An additional use for this machine is lifting and moving cars and light trucks. The optimum way to lift and move a car or light truck is from front to rear. This way is safe, because the side body panels don't get damaged and the undercarriage parts don't get damaged because the lifting is actually done on suspension points. To enable the forklift to lift in this manner requires 15′ forks as the 8 foot forks are too short to reach the rear suspension of the cars and light trucks. The system of the present invention described herein has been designed specifically for this fork truck, but can be applied to nearly any forklift or fork truck to adapt the carriage to enable other forks or other apparatus to be quickly and conveniently attached to the carriage.

While an improved interchangeable quick-coupling apparatus has been shown and described in detail in this application, it is to be understood that this invention is not to be considered to be limited to the exact form disclosed and changes in the detail and construction of the invention may be made without departing from the spirit thereof.

What is claimed is:

1. A quick coupler system installed on forklifts, fork trucks, wheel loaders, or backhoe loaders, equipped with a carriage, to provide the ability to attach an additional set of forks or some other apparatus to the carriage without having to remove the existing tines on the carriage.

2. The quick coupler system of claim 1 wherein said system does not require modification of an hydraulic system or controls on the forklift, fork trucks, wheel loaders, or backhoe loaders.

3. The quick coupler system of claim 1 wherein said system is installed on a forklift, fork truck, wheel loader, or backhoe loader, equipped with a hydraulic tine or fork positioner which allows the operator of such a machine to attach forks or other apparatus properly equipped with the system within a few seconds, while the machine operator is in the driver's compartment.

4. The quick coupler system of claim 1 wherein said forks are at least 15 feet in length.

5. The quick coupler system of claim 1 wherein said system is installed on a forklift or fork truck having carriages permanently attached to a mast and that have existing hydraulic sliding function.

6. The quick coupler system of claim 1, wherein said system does not require any modification to a machine's hydraulic system or controls.

7. The system of claim 1 wherein said quick coupler comprises shaft(s), mounting plates and guide plates secured on top of said carriage.

8. The system of claim 1 wherein said shaft comprises one shaft that goes across width of said carriage.

9. The system of claim 1 wherein said quick coupler comprises two shafts, mounting plates and guide plates secured on top of said carriage positioned in a equal horizontal manner.

10. The system of claim 7, further comprising:
hook assemblies secured to said forks or other apparatus.

11. A method for attaching forks or other apparatus to a forklift's or fork truck's carriage with existing tines comprising:
driving the forklift up to the forks or other apparatus;
lowering said carriage;
moving said tines to clear locking blocks;
aligning shafts with hook plates;
engaging a lift mechanism for said carriage when said shafts are under said hook plates;
securing said shafts to said hooks; and
engaging a hydraulic tine slide mechanism to cause said tines to slide over and lock onto locking block(s).

12. A method for attaching forks to a forklift or fork truck comprising:
driving up to quick coupler system;
lowering a carriage;
spreading tines apart enough to clear a locking block;
engaging a lift mechanism to move the carriage when shaft(s) is directly under hook plates;
securely hooking said shaft(s) to said hooking plates;
engaging a hydraulic tine side to side slide mechanism; and
sliding both tines toward center to pinch said locking blocks.

13. The method of claim 11 wherein said quick coupler system is fitted with two locking blocks and requires an operator to engage said hydraulic tine slide in a direction that would cause said tines to slide over and lock onto both of said locking blocks.
